(19) United States
(12) Patent Application Publication
(10) Pub. No.: US 2007/0199407 A1
(43) Pub. Date: Aug. 30, 2007

(54) Gear boxes having two motors and two output shafts

(76) Inventors: Emilio A. Ramirez, Roselle, IL (US); Athanase N. Tsergas, Wood Dale, IL (US); Ralph A. Bley, McHenry, IL (US)

Correspondence Address: Michael S. Leonard;EVEREST INTELLECTUAL PROPERTY LAW GROUP, P.O. Box 708, Northbrook, IL, 60065, US

(21) Appl. No.: 11/706,643

(22) Filed: Feb. 13, 2007

Related U.S. Application Data
(63) Continuation-in-part of application No. 11/362,786, filed on Feb. 28, 2006.

(51) Int. Cl. F16H 37/06

(52) U.S. Cl. 74/665 L

(57) ABSTRACT

A gear box has a housing and first and second direct current motors inside of the housing. A first rotatable output shaft extends through a wall of the housing and is rotatably driven by the first motor via a first gear train. A second rotatable output shaft extends through the wall of the housing and is rotatably driven by the second motor via a second gear train. The gear box can be used to dispense ice from a refrigerator/freezer. The first motor drives the first output shaft in one direction to dispense shaved ice. The second motor drives the second output shaft in one direction to dispense ice cubes and drives the second output shaft in an opposite direction to dispense crushed ice. The first and the second motors operate independently of each other.

### CROSS-REFERENCE TO RELATED APPLICATION

This application is a continuation-in-part patent application of copending U.S. patent application Ser. No. 11/362,786 filed on Feb. 28, 2006. This continuation-in-part application omits drawings and corresponding description from the parent application Ser. No. 11/362,786 which was incorrectly and inadvertently included in the parent application. Also, this continuation-in-part application includes additional disclosure of the invention. The invention of this application is an improvement upon the invention disclosed in U.S. patent application Ser. No. 09/315,852, now U.S. Pat. No. 6,054,785, which issued on Apr. 25, 2000.

### BACKGROUND OF THE INVENTION

This invention relates to machine elements and mechanisms generally, but more particularly to gear boxes with two motors driving two output shafts. In embodiments of the invention, compact gear boxes have two motors which independently drive two output shafts. The gear boxes can be used to dispense ice, including ice cubes, crushed ice, and shaved ice, from refrigerators/freezers or related products. The gear boxes can be used for other applications as well. The present invention also pertains to related methods, including methods of dispensing ice.

U.S. Pat. No. 6,054,785 to Kerdjoudj et al. issued on Apr. 25, 2000 and was assigned to the same assignee as the present invention. Kerdjoudj et al., upon which the present invention is an improvement, has a compact miniature gear motor box that includes a direct current motor, a worm gear, a pinion transfer gear, at least one cluster gear, an output gear and an output shaft. In Kerdjoudj et al., a single direct current motor drives a single output shaft. Because the single output shaft turns in two directions, it can carry out two functions. However, the Kerdjoudj et al. device can be improved.

It would be an improvement to provide a compact miniature gear motor box that has plural output shafts capable of performing more than two functions. It would also be an improvement to provide a gear box having two motors which independently drive two output shafts. Another improvement would be to provide a gear box for an ice maker of a refrigerator/freezer in which the gear box is capable of driving more than two ice dispensing functions, typically, not at the same time.

Accordingly, needs exist to improve gear boxes, such as gear boxes for refrigerator/freezer ice dispensers, for the reasons mentioned above and for other reasons.

### SUMMARY OF THE INVENTION

The present invention provides new gear boxes having two motors which independently drive two output shafts. The present invention is described in an embodiment of a gear box for use in a refrigerator/freezer to dispense ice. However, the present invention is broader than gear boxes for ice dispensers and is not limited to gear boxes for ice dispensers.

The present invention can provide a compact miniature gear box having two motors and two output shafts. The two motors are contained inside a single gear box housing, and each motor independently drives one of the two output shafts. One output shaft is reversible so that it performs a first function when rotated in one direction and performs a second function when rotated in an opposite direction. The other output shaft is not necessarily reversible, and it performs a third function when rotated in one direction. Thus, the two output shafts are capable of performing three different functions altogether.

In an embodiment of the present invention, the first motor is a permanent magnet direct current (PMDC) motor rotating one output shaft of the gear box in a clockwise (CW) direction to dispense ice cubes from an ice-making compartment in a refrigerator/freezer. The first PMDC motor can also rotate the same output shaft in a counterclockwise (CCW) direction to crush ice and dispense the crushed ice. The directions of the rotations of the motors and the output shafts can be reversed and perform the same functions. The second motor is likewise a PMDC motor. The second PMDC motor rotates its output shaft in only one direction and at a faster speed and a lower torque than the first motor in order to dispense shaved ice.

In some embodiments of the present invention, either one or both of the first and the second output shafts can be rotated in two directions by its respective motor. Also, either one or both of the first and the second output shafts can be rotated in only one direction by its respective motor.

Embodiments of the present invention may have various features and provide various advantages. Any of the features and advantages of the present invention may be desired, but, are not necessarily required to practice the present invention.

### BRIEF DESCRIPTION OF THE FIGURES

FIG. 1 is an exterior perspective view of a gear box having two motors and two output shafts according to the present invention.

FIG. 2 is another exterior perspective view of the gear box.

FIG. 3 is an interior perspective view of the gear box showing the two motors with worm gears.

FIG. 4 is another interior perspective view of the gear box with a partition plate supporting the motors removed.

FIG. 5 is a perspective view of a motor and gear assembly of the gear box, including the partition plate, two gear trains, and the two motors.

FIG. 6 is a schematic circuit diagram (circuit layout) including a printed circuit board of the gear box.

FIG. 7 is an interior plan view of another gear box having two motors and two output shafts according to the present invention.

FIG. 8 is a schematic diagram of two motors and two output shafts of a gear box according to the present invention.

### DETAILED DESCRIPTION OF THE INVENTION

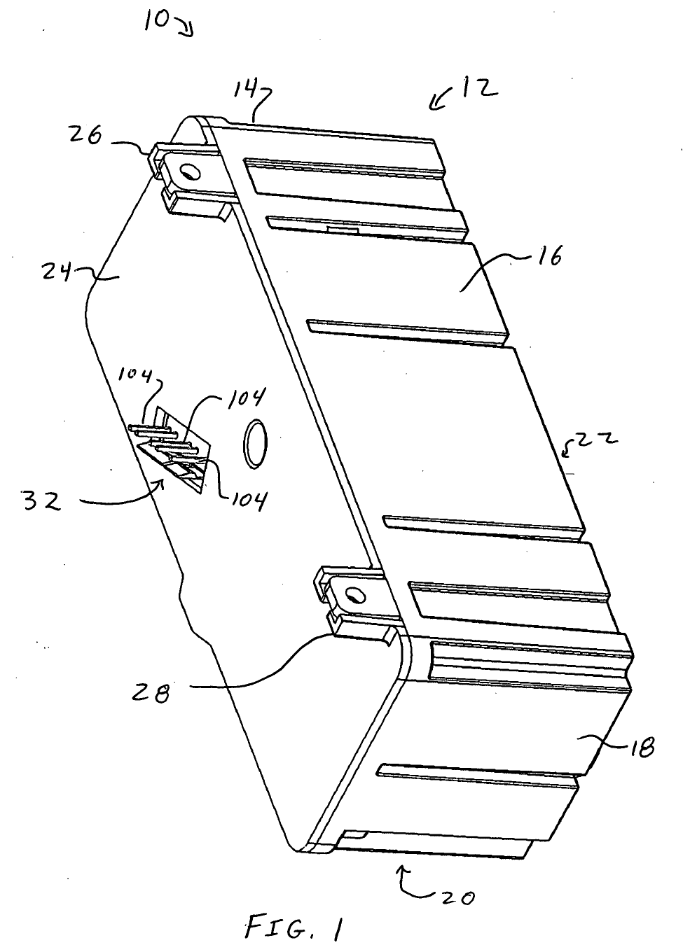

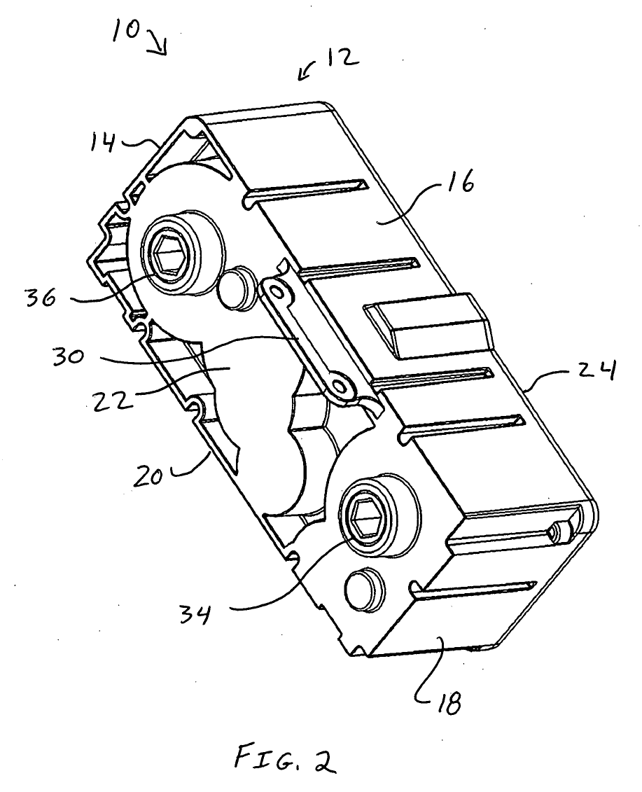

One example of a gear box 10 having two motors and two output shafts according to the present invention is shown in FIGS. 1-5. FIGS. 1 and 2 show exterior views of opposite sides of the gear box 10. The gear box 10 has a closed housing 12 with side walls 14, 16, 18, 20, 22, and a removable cover 24. The gear box 10 has mounting brackets 26, 28, 30, on its exterior for mounting the gear box 10, for example inside of an ice-making compartment of a refrigerator/freezer (not shown). Referring to FIG. 1, an electrical connection 32 is provided through the cover 24 of the housing 12 for the electrical components inside of the gear box 10. An electrical power source (not shown) provides electric power, such as direct current, through the electrical connection 32 to the motors inside of the gear box 10. Referring to FIG. 2, the gear box 10 has first and second rotatable output shafts 34, 36 which extend through the side wall 22 and provide rotational driving forces. The first and second output shafts 34, 36 are female hex shafts which can be engaged with male hex shafts of an ice dispenser mechanism (not shown). Also, the longitudinal axis of the first output shaft 34 is parallel to the longitudinal axis of the second output shaft 36.

The first and second output shafts 34, 36 can be coupled to shafts of the refrigerator/freezer that deliver ice cubes, crushed ice, and shaved ice. The first and second output shafts 34, 36 are hollow hex shafts (female hex shafts) that are driven at desired speeds and torques by separate gear trains inside of the gear box 10. The hollow hex first and second output shafts 34, 36 allow for quick coupling to the corresponding shafts of the refrigerator/freezer, and effectively transmit torque to the refrigerator/freezer shafts. Other shaft designs or output mechanisms could be used for the first and second output shafts 34, 36. Round shafts and flat shafts (D shape) are just two examples. However, hollow hex shafts can provide the advantages of easy coupling and effective torque transmission.

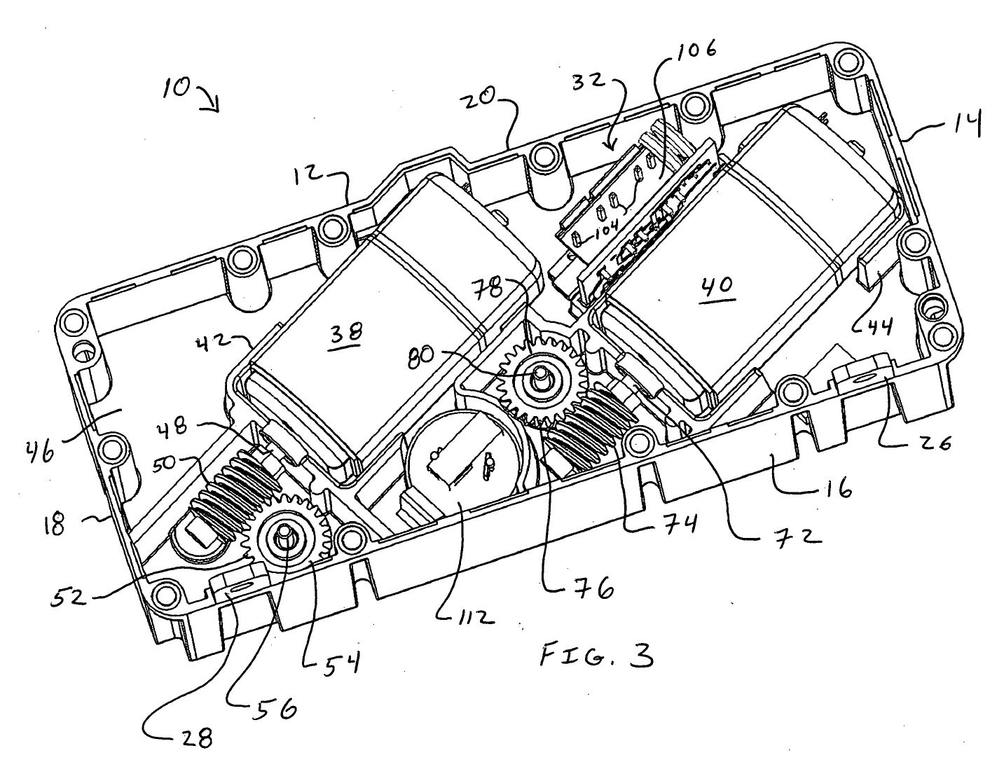

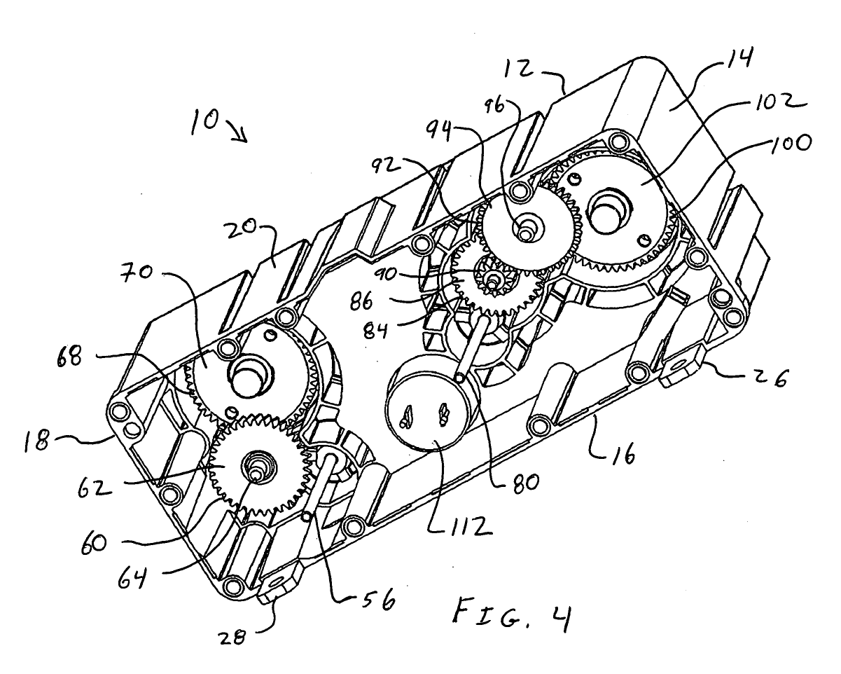

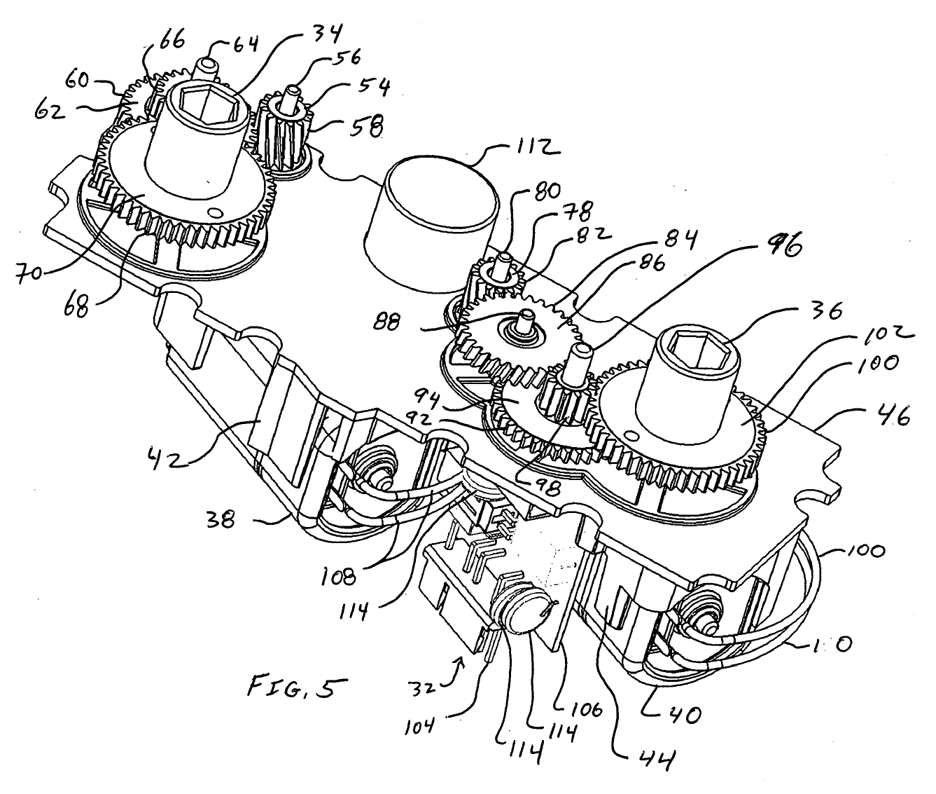

The components of the gear box 10 inside of the housing 12 will now be described with reference to FIGS. 3-5. FIG. 3 shows a perspective view of the inside of the gear box 10 with the cover 24 removed. The gear box 10 has first and second motors 38, 40 positioned in motor holding receptacles 42, 44 of a partition plate 46. The partition plate 46 separates the interior of the housing 12 of the gear box 10 into two portions, one interior portion above the partition plate 46 as shown in FIG. 3 and another interior portion below the partition plate 46 of FIG. 3. The interior portion below the partition plate 46 is shown in FIG. 4. FIG. 5 is a perspective view showing various components of the gear box 10 on both sides of the partition plate 46.

The first and second motors 38, 40 are direct current (DC) motors which are capable of rotating their respective motor shafts in both clockwise and counterclockwise directions. The first motor 38 has a motor shaft 48 which is connected to and drives a worm gear 50. The worm gear 50 is engaged with outer teeth 52 of a pinion gear 54 on the motor side of the partition plate 46. The pinion gear 54 extends through a hole in the partition plate 46 and is rotatable about a shaft 56. Inner teeth 58 of the pinion gear 54 on the output shaft side of the partition plate 46 are engaged with outer teeth 60 of a gear 62 rotatable about a shaft 64. Inner teeth 66 of the gear 62 are engaged with the teeth 68 of a spur gear 70 having the first output shaft 34. The gear train of the first motor 38 is relatively short and is designed to provide higher rotational speed and lower torque of the first output shaft 34. The high speed, low torque rotation of the first output shaft 34 can be beneficial for driving an ice shaver to shave ice. The first motor 38 is operated in only one direction which operates the first output shaft 34 in one direction to provide the function of shaving ice, for example.

The second motor 40 has a motor shaft 72 which is connected to and drives a worm gear 74. The worm gear 74 is engaged with outer teeth 76 of a pinion gear 78 on the motor side of the partition plate 46. The pinion gear 78 extends through a hole in the partition plate 46 and is rotatable about a shaft 80. Inner teeth 82 of the pinion gear 78 on the output shaft side of the partition plate 46 are engaged with outer teeth 84 of a gear 86 rotatable about a shaft 88. Inner teeth 90 of the gear 86 are engaged with the outer teeth 92 of a gear 94 rotatable about a shaft 96. The inner teeth 98 of the gear 94 are engaged with teeth 100 of a spur gear 102 having the second output shaft 36. The gear train of the second motor 40 is relatively long and is designed to provide lower rotational speed and higher torque of the second output shaft 36. The low speed, high torque rotation of the second output shaft 36 can be beneficial for driving an ice crusher to crush ice or to dispense ice cubes. The second motor 40 is operated in two directions. One direction of the second motor 40 operates the second output shaft 36 in one direction to provide the function of dispensing ice cubes, for example. The other opposite direction of the second motor 40 operates the second output shaft 36 in the opposite direction to provide the function of crushing ice, for example.

Referring to FIG. 3, one feature of the gear box 10 is that the first and second motors 38, 40 are positioned and arranged within the housing 12 such that the motor shafts 56, 72 are parallel to each other. Also, the motor shafts 56, 72 are pointing in the same direction. Furthermore, the first and second output shafts 34, 36 have axes which are generally perpendicular to axes of their respective motor shafts 56, 72. Another feature of the gear box 10 is that the first and second motors 38, 40 can be operated independently of each other, as will be further explained below. Accordingly, one of the first and second motors 38, 40 can provide a first function of the gear box 10 by driving the respective output shaft 34, 36. And, the other motor of the first and second motors 38, 40 can provide a second function of the gear box 10, independent of the first function, by independently driving the respective output shaft 34, 36. An even further feature of the gear box 10 is that one or both of the first and second motors 38, 40 can be operated in forward and reverse directions, which allows the gear box 10 to provide even more functions by driving the first and second output shafts 34, 36 in certain directions.

Referring to FIGS. 3 and 5, the electrical connection 32 has a plurality of pins 104 and is a component of a circuit board 106. The first and second motors 38, 40 are electrically connected to the circuit board 106 by wires 108, 110. A large capacitor 112 is electrically connected to the circuit board 106 and provided in the electrical circuit of the first motor 38. The large capacitor 112 allows the first motor 38 to operate at a relatively high speed which can be beneficial for driving an ice shaver to shave ice. The circuit board 106 also has two positive temperature coefficients (PTC) 114 for the first motor 38 and one PTC 114 for the second motor 40. The PTC's 114 provide protection for the windings of the first and second motors 38, 40.

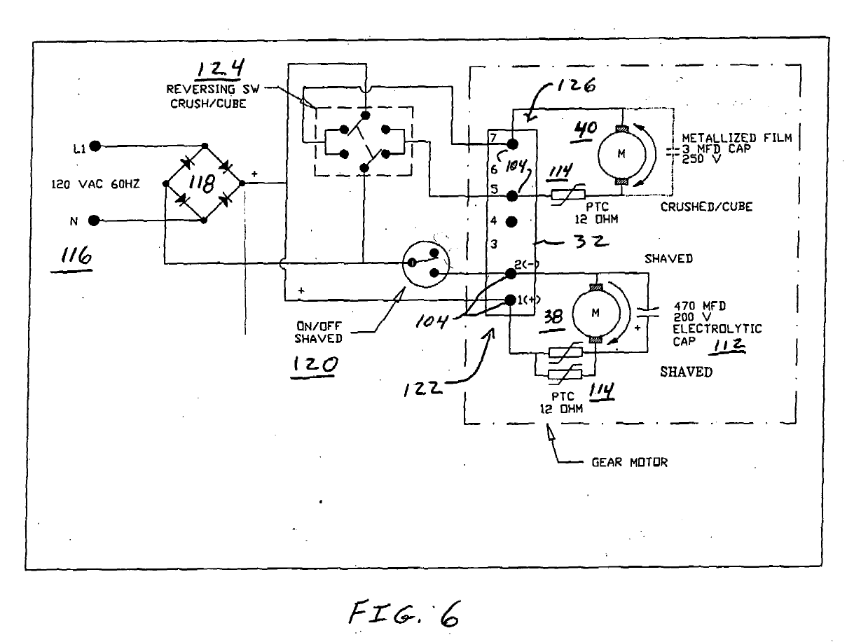

FIG. 6 shows a schematic diagram of an electrical circuit. An AC power source 116 is provided to the refrigerator/freezer which has a converter 118 that converts the AC current to DC current. The refrigerator/freezer has a shaved ice dispensing switch 120 connected to the DC power and to a first motor portion 122 of the electrical connection 32 of the circuit board 106 of the gear box 10. The first motor 38 is electrically connected to the first motor portion 122 of the electrical connection 32. Accordingly, the shaved ice dispensing switch 120 operates the first motor 38 to drive the first output shaft 34 to dispense shaved ice. The first motor 38 rotates in one direction which drives its gear train and rotates the first output shaft 34 in one direction. The first output shaft 34 rotates to drive an ice shaver of the refrigerator/freezer to shave ice and dispense the shaved ice.

The refrigerator/freezer also has a reversing switch 124 for alternatively dispensing ice cubes and crushed ice. The ice cube/crusher reversing switch 124 is connected to the DC power and to a second motor portion 126 of the electrical connection 32 of the circuit board 106 of the gear box 10. The second motor 40 is electrically connected to the second motor portion 126 of the electrical connection 32. Accordingly, the ice cube/crusher reversing switch 124 operates the second motor 40 in one direction to drive the second output shaft 36 in one direction to dispense ice cubes, and the ice cube/crusher reversing switch 124 operates the second motor 40 in a second, reverse direction to drive the second output shaft 36 in a second, reverse direction to crush ice and dispense the crushed ice.

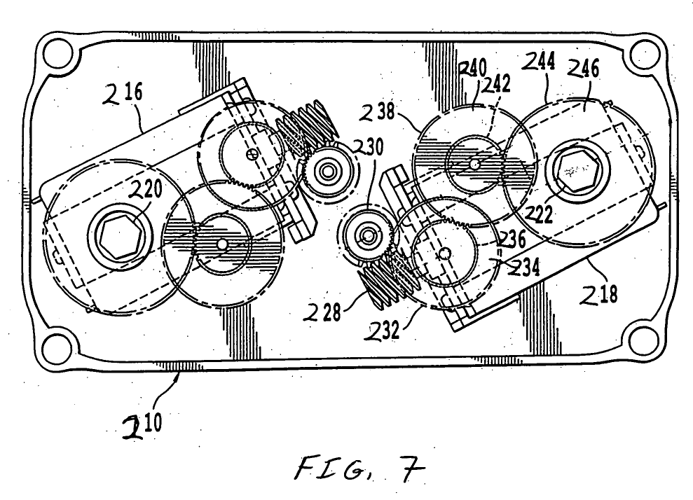

Another embodiment of the present invention is shown in FIG. 7. A gear box 200 has first and second motors 216, 218 which drive first and second output shafts 220, 222, respectively. Because the first motor 216 is identical in structure and operates independently from the second motor 218, only the elements and operation of the second motor 218 will be described. Electrical current from a receptacle enters the second motor 218 so that the second motor 218 drives a worm 228 which turns a pinion gear 230 that meshes with outer teeth 232 of a first cluster gear 234. Inner teeth 236 of the first cluster gear 234 mesh with outer teeth 238 of a second cluster gear 240. Inner teeth 242 of the second cluster gear 240 then mesh with outer teeth 244 of an output gear 246 that drives the second output shaft 222. Note that cross-sections of the first output shaft 220 and the second output shaft 222 are hexagon-shaped. The second output shaft 222 is driven at a faster speed and a lower torque than the first output shaft 220 so that shaved ice is dispensed from the ice-making compartment (not shown).

Note that the longitudinal axis of the first output shaft 220 is parallel to the longitudinal axis of the second output shaft 222. Also, the axes of the motor shafts of the first and second motors 216, 218 are parallel to each other and point in opposite directions.

The operation of the invention in the embodiment of the gear box 210 may be described as follows. Initially, the first motor 216 is set to be reversible so that the first output shaft 220 may rotate in on direction to dispense ice cubes and in the opposite direction to dispense crushed ice. Then, the second motor 218 is set to operate so that the second output shaft 222 rotates in one direction to dispense shaved ice.

The operation voltage for the gear box 210 may vary at either 50 Hz or 60 Hz from 12 to 48 volts of direct current (VDC) or from 120 to 220 volts of alternation current (VAC) rectified.

From here on, for the sake of simplicity, reference is made only to the operation of the second motor 218 and its associated elements. When a user desires shaved ice, he or she depresses a button on the ice-making compartment of the refrigerator (not shown). Direct current is supplied to the motor 218 so that the motor 218 causes rotation of the worm 228. This worm 228 turns the pinion gear 230. The teeth on the end of the pinion gear 230 away from the worm 228 mesh with the outer teeth 232 on the first cluster gear 234. The inner teeth 242 of the second cluster gear 240 mesh with the teeth 244 of the output gear 246 that drives the output shaft 222 to dispense the desired shaved ice into a receptacle of the user.

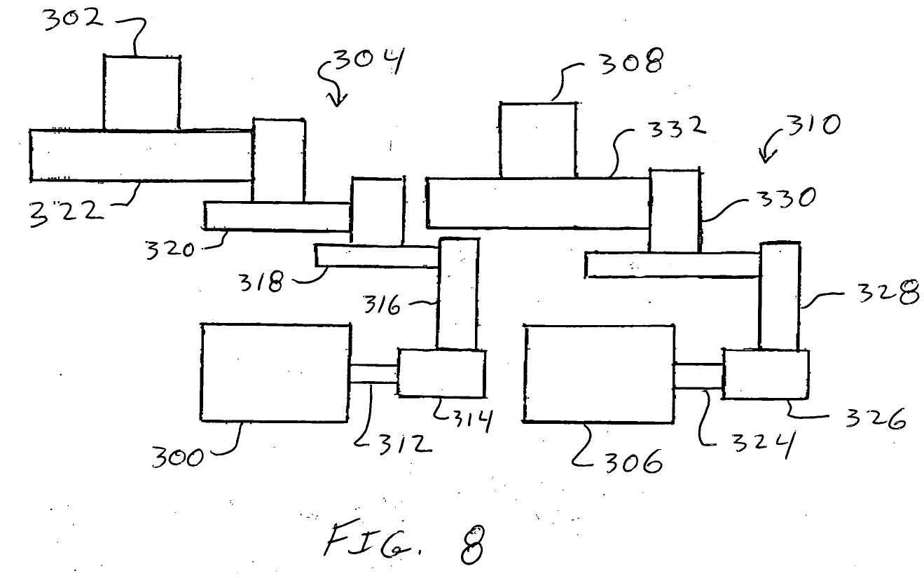

FIG. 8 is a schematic diagram of two motors and two output shafts of a gear box according to the present invention. The gear box has a first motor 300 operatively connected to a first output shaft 302 by a first gear train 304. The gear box also has a second motor 306 operatively connected to a second output shaft 308 by a second gear train 310. The first and second gear trains 304, 310 are designed to provide desired rotational outputs of the first and second output shafts 302, 308. FIG. 8 shows examples of the first and second gear trains 304, 310 and other gear trains can be used as desired.

A motor shaft 312 of the first motor 300 is connected to a worm gear 314. The worm gear 314 is engaged with a stem gear 316 which is engaged with a gear 318 which is engaged with a gear 320. The gear 320 is engaged with an output gear 322 connected to the output shaft 302.

A motor shaft 324 of the second motor 306 is connected to a worm gear 326 which is engaged with a stem gear 328. The stem gear 328 is engaged with a gear 330. The gear 330 is engaged with an output gear 332 which is connected to the second output shaft 308.

Accordingly, the first and second motors 300, 306 operatively drive the first and second output shafts 302, 308 via the first and second gear trains 304, 310, respectively.

Numerous modifications and variations of the present invention are possible in light of the above teachings. The present invention has been described in terms of gear boxes for use in refrigerators/freezers for dispensing ice in several forms. However, the present invention is broader than that and can be used for other applications. Also, different gear trains or force transfer mechanisms can be used to drive the output shafts by the motors. For example, instead of using the worm as the input drive gear from the motor, a bevel gear, a helical gear, a spur gear or any other type of gear or combination of gears could be used. The other gears could also be changed as desired.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A gear box comprising:
a housing;
a first direct current motor inside of the housing;
a first rotatable output shaft extending through a wall of the housing and rotatably driven by the first motor;
a second direct current motor inside of the housing; and
a second rotatable output shaft extending through the wall of the housing and rotatably driven by the second motor.

2. A gear box according to claim 1, wherein the first and second motors operate independently of each other and independently drive the first and second output shafts.

3. A gear box according to claim 1, wherein the first motor has a motor shaft and the second motor has a motor shaft, the motor shafts of the first and second motors aligned substantially parallel to each other.

4. A gear box according to claim 3, wherein the motor shafts of the first and second motors point in generally the same direction.

5. A gear box according to claim 3, wherein the motor shafts of the first and second motors point in generally opposite directions.

6. A gear box according to claim 3, wherein the first output shaft is generally perpendicular to the motor shaft of the first motor and the second output shaft is generally perpendicular to the motor shaft of the second motor.

7. A gear box according to claim 1, wherein the first output shaft is generally perpendicular to a motor shaft of the first motor and the second output shaft is generally perpendicular to a motor shaft of the second motor.

8. A gear box according to claim 1, wherein the second motor operates at a different speed and torque than the first motor.

9. A gear box according to claim 1, wherein cross-sections of the first and the second output shafts are hexagon-shaped.

10. A gear box according to claim 1, wherein a longitudinal axis of the first output shaft is generally parallel to a longitudinal axis of the second output shaft.

11. A gear box according to claim 1, further comprising:
a first gear train operatively connecting the first motor to the first output shaft; and
a second gear train operatively connecting the second motor to the second output shaft.

12. A gear box according to claim 1, wherein the first motor drives the first output shaft in one rotational direction; and
wherein the second motor drives the second output shaft in two rotational directions.

13. A gear box for driving an ice dispenser, comprising:
a housing;
a first direct current motor inside of the housing;
a first output shaft extends through a wall of the housing and is driven by the first motor via a first gear train in one direction to dispense shaved ice;
a second direct current motor inside of the housing; and
a second output shaft extends through the wall of the housing and is driven by the second motor via a second gear train, the second output shaft is driven in one direction to dispense ice cubes and driven in an opposite direction to dispense crushed ice.

14. A gear box according to claim 13, wherein the first and second motors operate independently of each other and independently drive the first and second output shafts.

15. A gear box according to claim 13, wherein the first motor has a motor shaft and the second motor has a motor shaft, the motor shafts of the first and second motors aligned substantially parallel to each other.

16. A gear box according to claim 15, wherein the motor shafts of the first and second motors point in generally the same direction.

17. A gear box according to claim 15, wherein the motor shafts of the first and second motors point in generally opposite directions.

18. A gear box according to claim 15, wherein the first output shaft is generally perpendicular to the motor shaft of the first motor and the second output shaft is generally perpendicular to the motor shaft of the second motor.

19. A gear box according to claim 13, wherein the first output shaft is generally perpendicular to a motor shaft of the first motor and the second output shaft is generally perpendicular to a motor shaft of the second motor.

20. A gear box according to claim 13, wherein the second motor operates at a different speed and torque than the first motor.

21. A gear box according to claim 13, wherein a longitudinal axis of the first output shaft is generally parallel to a longitudinal axis of the second output shaft.

22. A method of dispensing ice, comprising:
rotating a first output shaft of a gear box by a first motor to dispense ice in a first form;
rotating a second output shaft of the gear box in a first direction by a second motor to dispense ice in a second form; and
rotating the second output shaft of the gear box in a second direction opposite to the first direction by the second motor to dispense ice in a third form;
wherein the first and second motors rotate the first and second output shafts, respectively, independent of each other.

23. A method of dispensing ice according to claim 22, wherein the first output shaft is rotated a higher speed and lower torque relative to the rotation of the second output shaft.

24. A method of dispensing ice according to claim 22, wherein rotating the first output shaft dispenses shaved ice, rotating the second output shaft in the first direction dispenses ice cubes, and rotating the second output shaft in the second direction dispenses crushed ice.
